(19) United States
(12) Patent Application Publication
(10) Pub. No.: US 2015/0038174 A1
(43) Pub. Date: Feb. 5, 2015

(54) DISPLAY APPARATUS AND METHOD FOR CONTROLLING THEREOF

(71) Applicant: SAMSUNG ELECTRONICS CO., LTD., Suwon-si (KR)

(72) Inventors: Ji-ho CHU, Seoul (KR); Jeong-hun PARK, Yongin-si (KR)

(73) Assignee: SAMSUNG ELECTRONICS CO., LTD., Suwon-si (KR)

(21) Appl. No.: 14/299,377

(22) Filed: Jun. 9, 2014

(30) Foreign Application Priority Data
Jul. 31, 2013 (KR) 10-2013-0091028

(51) Int. Cl. H04W 4/02; H04W 64/00

(52) U.S. Cl. CPC H04W 4/028; H04W 64/00
USPC 455/456.3

(57) ABSTRACT

A communication apparatus is provided. The communication apparatus includes a communication unit configured to receive point of interest (POI) information from a POI server, a storage configured to store the received POI information, a location information receiver configured to receive location information on the communication apparatus, and a controller configured to determine whether there is a user activity on a POI based on the location information received by the location information receiver and the POI information stored in the storage, and store activity POI information according to the determined user activity in the storage.

### CROSS-REFERENCE TO RELATED APPLICATIONS

This application claims priority under 35 U.S.C. §119 from Korean Patent Application No. 10-2013-0091028, filed on Jul. 31, 2013 in the Korean Intellectual Property Office, the disclosure of which is incorporated herein by reference in its entirety.

### BACKGROUND

1. Field

The present exemplary embodiments generally relate to a display apparatus and a method for controlling thereof, and more particularly, to a point of interest (POI) based-communication apparatus and a method for controlling thereof.

2. Description of the Related Art

A display apparatus in the related art provides a POI service that, when a user approaches a POI related to a concerned area or concerned item which is preregistered by a user among POI information received from a POI sever, informs the user of the approach to the POI.

That is, the display apparatus in the related art merely provides a service of informing that a user enters into an area of the POI based on location information on the user and location information on the POI related to a concerned area or concerned item registered by the user. Accordingly, the user is able to recognize that he/she is located on the POI related to the concerned area or concerned item through the POI service.

That is, the user is merely able to recognize whether he/she is located on the POI related to the concerned area or concerned item according to the user's movement state through the POI service, and is not able to know a log history which shows POIs where the user conducted activities in the past.

### SUMMARY

An aspect of the exemplary embodiments provide a communication apparatus and a method for controlling thereof, to provide a routine log according to a user's activity as data based on location information and POI information on the user.

A communication apparatus according to an exemplary embodiment for achieving the aforementioned purpose includes a communication unit configured to receive point of interest (POI) information from a POI server, a storage configured to store the received POI information, a location information receiver configured to receive location information on the communication apparatus, and a controller configured to determine whether there is a user activity on a POI based on the location information received from the location information receiver and the POI information stored in the storage, and store activity POI information according to the determined user activity in the storage.

The apparatus may further include a category unit configured to categorize the received POI information based on a predetermined hierarchical categorization condition, and store the categorized POI information in the storage.

When the communication apparatus is located within a predetermined range of the POI based on the categorized POI information and the received location information on the communication apparatus, the controller may determine that there is a user activity on the POI.

In addition, when the communication apparatus is located on the POI for a predetermined time based on the location information on the communication apparatus, the controller may determine that there is a user activity on the POI.

The apparatus may further include a display. In addition, the controller may control the display to display the activity POI information based on time information included in the activity POI information stored in the storage.

The controller may control the display to determine a ratio of each of activity POI information with respect to entire activity POI information based on the time information included in the activity POI information stored in the storage, and display each of the activity POI information according to a category based on the determined ratio.

In addition, the controller may control the display to display the activity POI information on a pre-stored map based on the time information and the location information included in the activity POI information stored in the storage.

The communication unit may receive location information on the communication apparatus from at least one preregistered terminal apparatus periodically. In addition, when the at least one preregistered terminal apparatus is located within a predetermined range of the POI or located on the POI for a predetermined time based on the location information on the at least one preregistered terminal apparatus, the controller may determine that there is a sharing activity on the POI between a user of the at least one preregistered terminal apparatus and a user of the communication apparatus, and may match and store sharing activity information on the determined sharing activity with the activity POI information in the storage.

The apparatus may further include a display. In addition, the controller may control the display to display the activity POI information and the sharing activity information based on the time information included in the activity POI information and the sharing activity information stored in the storage.

The controller may control the display to determine a ratio of each of sharing activity information with respect to entire sharing activity information based on the time information included in the sharing activity information stored in the storage, and display each of the sharing activity information based on the determined ratio.

Meanwhile, according to an exemplary embodiment, a method for controlling a communication apparatus includes receiving POI information from a POI server, storing the received POI information, receiving location information on the communication apparatus, determining whether there is a user activity on a POI based on the received location information and the stored POI information, and storing activity POI information according to the determined user activity.

The storing the received POI information may further include categorizing and storing the received POI information based on a predetermined hierarchical categorization condition.

The determining may include, when the communication apparatus is located within a predetermined range of the POI based on the categorized POI information and the received location information on the communication apparatus, determining that there is a user activity on the POI.

In addition, the determining may include, when the communication apparatus is located on the POI for a predetermined time based on the location information on the communication apparatus, determining that there is a user activity on the POI.

The method may further include displaying the activity POI information based on time information included in pre-stored activity POI information.

The displaying may include determining a ratio of each of activity POI information with respect to entire activity POI information based on time information included in the pre-stored activity POI information, and displaying each of the activity POI information according to a category based on the determined ratio.

The displaying may include displaying the activity POI information on a pre-stored map based on the time information and the location information included in the pre-stored activity POI information.

The receiving location information may further include periodically receiving location information on the communication apparatus from at least one preregistered terminal apparatus. In addition, the determining may include, when the at least one preregistered terminal apparatus is located within a predetermined range of the POI or located on the POI for a predetermined time based on the location information on the at least one preregistered terminal apparatus, determining that there is a sharing activity on the POI between a user of the at least one preregistered terminal apparatus and a user of the communication apparatus. In addition, the storing activity POI information may further include matching and storing sharing activity information on the determined sharing activity with the activity POI information.

The method may further include displaying the activity POI information and the sharing activity information based on the time information included in the pre-stored activity POI information and the sharing activity information.

The displaying may include determining a ratio of each of sharing activity information with respect to entire sharing activity information based on the time information included in the pre-stored sharing activity information, and displaying the sharing activity information based on the determined ratio.

As above, according to various exemplary embodiments, a communication apparatus may provide a log according to a user activity as data based on location information and POI information on the user.

### BRIEF DESCRIPTION OF THE DRAWINGS

The above and/or other aspects will be more apparent by describing certain exemplary embodiments with reference to the accompanying drawings, in which:

FIG. 1 is a view of a POI system which manages a POI-based user activity according to an exemplary embodiment;

FIG. 2 is a block diagram of a display apparatus according to an exemplary embodiment;

FIG. 3 is a first demonstration diagram which illustrates an operation of displaying a result analyzed based on activity POI information on a display apparatus according to an exemplary embodiment;

FIG. 4 is a second demonstration diagram which illustrates an operation of displaying a result analyzed based on activity POI information on a display apparatus according to another exemplary embodiment;

FIG. 5 is a demonstration diagram which illustrates an operation of displaying a result analyzed based on activity POI information and sharing activity information on a display apparatus according to an exemplary embodiment;

FIG. 6 is a demonstration diagram which illustrates an operation of displaying a result analyzed based on sharing activity information on a display apparatus according to another exemplary embodiment;

FIG. 7 is a flow chart which illustrates a method for controlling a display apparatus according to an exemplary embodiment; and

FIG. 8 is a flow chart which illustrates a method of providing an analysis result of a user activity according to a sharing activity on a display apparatus according to an exemplary embodiment.

### DETAILED DESCRIPTION

Certain exemplary embodiments are described in greater detail below with reference to the accompanying drawings.

In the following description, like drawing reference numerals are used for the like elements, even in different drawings. The matters defined in the description, such as detailed construction and elements, are provided to assist in a comprehensive understanding of exemplary embodiments. However, exemplary embodiments can be practiced without those specifically defined matters. Also, well-known functions or constructions are not described in detail since they would obscure the application with unnecessary detail.

Expressions such as “at least one of,” when preceding a list of elements, modify the entire list of elements and do not modify the individual elements of the list.

Hereinafter, the term “unit” refers to a software component, or a hardware component such as FPGA or ASIC, and performs a certain function. However, the “unit” is not limited to software or hardware. The “unit” may be configured in an addressable storage medium and may be configured to be executed by one or more processors. Hence, the “unit” includes elements such as software elements, object-oriented software elements, class elements, and task elements, and processes, functions, attributes, procedures, subroutines, segments of program codes, drivers, firmware, micro-codes, circuits, data, databases, data structures, tables, arrays, and variables. The functions provided in the elements and the units may be combined into a fewer number of elements and units or may be divided into a larger number of elements and units.

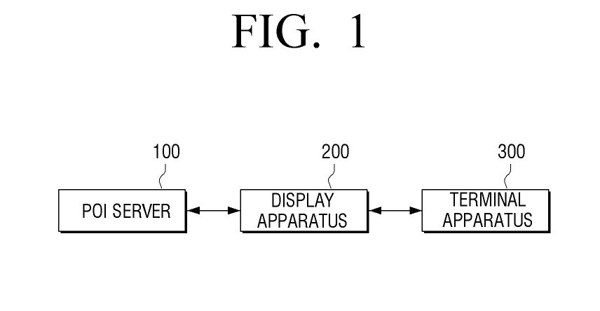

FIG. 1 is a view of a POI system which manages a POI-based user activity according to an exemplary embodiment.

As shown in FIG. 1, a POI (Point of Interest) system includes a POI server 100 and a display apparatus 200.

The POI server 100 stores POI information on a concerned area such as a tourist spot or a concerned object such as public institutions, public facilities, commercial facilities, and the like, according to a user's request. Such POI information may include additional information including location information, name information, and contact information on the concerned area or the concerned object. The POI server 100 which stores such POI information may update pre-stored POI information, or may generate and store new POI information according to a user's request.

The display apparatus 200 is a mobile communication terminal apparatus capable of wireless communication such as a smart phone and a tablet PC, and determines whether there is a user activity on a POI corresponding to at least one of the concerned area and the concerned object, based on POI information received from the POI server 100 through the wireless communication and location information on the display apparatus 200.

To be specific, the display apparatus 200 may periodically receive and store a plurality of POI information which are pre-stored in the POI server 100 from the POI server 100. In addition, the display apparatus 200 may periodically receive current location information on the display apparatus 200 from a GPS (Global Positioning System) satellite (not shown). Accordingly, when location information on the display apparatus 200 is received from the GPS satellite (not shown), the display apparatus 200 may determine whether there is a user activity on at least one POI, based on the received location information and the plurality of pre-stored POI information.

For example, when location information on the display apparatus 200 received from a GPS satellite (not shown) is located within a predetermined range of POI information on “OOO Library,” the display apparatus 200 may determine that a user of the display apparatus 200 conducted an activity on POI of “OOO Library.”

In addition, when it is determined that the display apparatus 200 is located on the POI of “OOO Library” for a predetermined time based on location information on the display apparatus 200, which is periodically received from a GPS satellite (not shown), the display apparatus 200 may determine that a user conducted an activity on the POI of “OOO Library.”

Based on the above condition, when it is determined that a user conducted an activity on a particular POI, the display apparatus 200 generates and stores activity POI information according to the user activity on the POI. Subsequently, when a user command is inputted, the display apparatus 200 displays an analysis result of a user activity according to a period, based on time information included in the plurality of pre-stored activity POI information. Accordingly, the user is able to monitor his/her activity history based on the analysis result of the user activity displayed by the display apparatus 200.

Meanwhile, as shown in FIG. 1, the display apparatus 200 transmits and receives location information on the display apparatus 200 by performing data communication with a preregistered terminal apparatus 300. As specified above, when it is determined that the user of the display apparatus 200 conducted an activity on the POI of “OOO Library,” location information on the terminal apparatus 300 may be received from the terminal apparatus 300. In this case, the display apparatus 200 determines whether the terminal apparatus 300 is located within a predetermined range of the POI of “OOO Library” or on the POI of “OOO Library” for a predetermined time, based on the received location information of the terminal apparatus 300. When it is determined that the terminal apparatus 300 is located within the predetermined range of the POI of “OOO Library” or on the POI of “OOO Library” for the predetermined time, the display apparatus 200 determines that there is a sharing activity on the POI of “OOO Library” between a user of the terminal apparatus 300 and a user of the display apparatus 200. Accordingly, the display apparatus 200 matches and stores sharing activity information corresponding to the sharing activity on the POI.

When a user command is inputted, the display apparatus 200 displays an analysis result of a user activity according to a period, based on the time information included in the plurality of pre-stored activity POI information and the sharing activity information. Accordingly, the user is able to monitor his/her activity history based on the analysis result of the user activity displayed by the display apparatus 200, and is able to monitor a sharing activity history between the user and an acquaintance.

As above, the POI system which manages POI-based user activity has been explained schematically. Hereinafter, each configuration of the aforementioned display apparatus 200 will be explained more specifically.

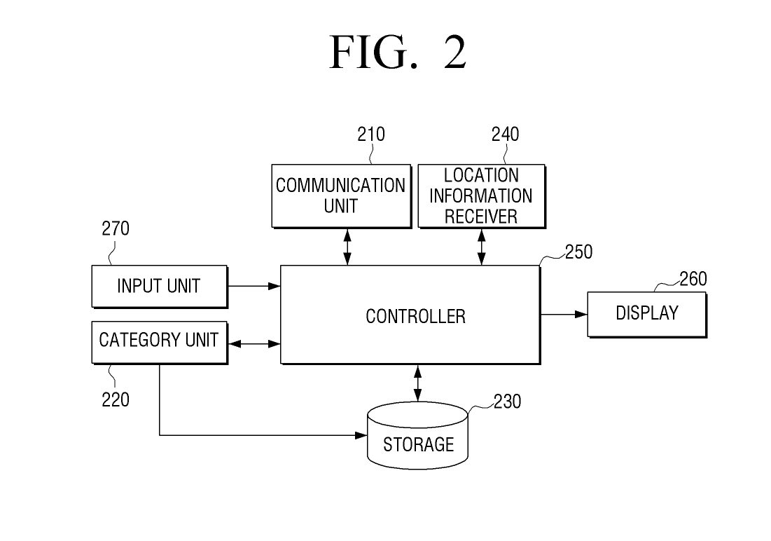

FIG. 2 is a block diagram of a display apparatus according to an exemplary embodiment.

As shown in FIG. 2, the display apparatus 200 includes a communication unit 210, a category unit 220, a storage unit (“storage”) 230, a location information receiver 240, a controller 250, and a display 260.

The communication unit 210 performs communication with the POI server 100. To be specific, the communication unit 210 performs communication with the POI server 100, and periodically receives POI information which is pre-stored in the POI server 100. Herein, the POI information is information related to a concerned area such as a tourist spot, a vacation spot, and the like, and a concerned object such as the public institution, the public facilities, the commercial facilities, and the like, and may include additional information such as location information, name information, and contact information on the concerned area or the concerned object. Further, the communication unit 210 may perform communication with the terminal apparatus 300. To be specific, the communication unit 210 performs communication with the circumjacent terminal apparatus 300 capable of wireless communication, such as a smart phone, and transmits and receives location information received from the GPS satellite (not shown).

The communication unit 210 may be embodied as a communication module such as a wireless communication module (not shown), a local area wireless communication module (not shown), and the like. Herein, the wireless communication module (not shown) performs communication with the POI server 100 by accessing to mobile communication network according to various mobile communication standards such as Wi-Fi, 3G (3rd Generation), 3GPP (3rd Generation Partnership Project), LTE (Long Term Evolution), and the like. In addition, the local area wireless communication module (not shown) is a communication module which performs wireless communication with the terminal apparatus 300 which is located in a close area, and for example, may be Bluetooth, Zigbee, NFC (Near Field Communication), and the like.

The category unit 220 categorizes a plurality of POI information received from the POI server 100 through the communication unit 210 based on a predetermined hierarchical categorization condition, and stores the categorized POI information in the storage 230. Herein, the hierarchical categorization condition is information for determining a category based on name information included in each POI information. Accordingly, the category unit 220 may determine a category which meets the hierarchical categorization condition based on the name information included in the POI information.

For example, POI information on a school, a hospital, a police station, and a fire station may be classified into a category regarding the public institution, and POI information on a library, a civic center, health and welfare facilities, and a park may be classified into a category regarding the public facilities. In addition, POI information on a market, a department store, a restaurant, a cafe, and an office building may be classified into a category regarding the commercial facilities, and POI information on a bathing beach, a camping ground, an arboretum, and an amusement park may be categorized into a category regarding a tourist spot. In addition, POI information which is registered on the POI server 100 by the user of the display apparatus 200 may be classified into a category regarding a personal setting. For example, when POI information on a home of the user is registered on the POI server 100 by the user, the POI information on the home may be classified into a category regarding the personal setting. As such, when a category of each POI information is classified, the category unit 220 stores the POI information classified according to a category in the storage 230.

Meanwhile, according to an additional aspect, the category unit 220 may set at least one of a critical range and a critical time differently according to a category. For example, in a category regarding the tourist spot, the critical range of the category may be set to be broader than a critical range of other categories, or the critical time of the category may be set to be longer than a critical time of other categories. In addition, in a category regarding the public institution, the critical range of the category may be set to be narrower than the critical range of other categories, or the critical time of the category may be set to be shorter than the critical time of other categories.

Accordingly, the storage 230 may match and store the plurality of POI information received from the POI server 100 according to a category, and may match and store critical range information or critical time information which is set according to each category.

The location information receiver 240 periodically receives location information on the display apparatus 200 from the GPS satellite (not shown).

The controller 250 determines whether there is a user activity on a particular POI based on location information received from the location information receiver 240 and POI information which is pre-stored in the storage 230. Subsequently, the controller 250 generates and stores activity POI information according to the determined user activity in the storage 230.

According to an exemplary embodiment, when it is determined that the display apparatus 200 is located within a predetermined range of the particular POI based on POI information classified according to a category and the location information on the display apparatus 200 received from the GPS satellite (not shown), the controller 250 determines that there is a user activity on the POI.

According to another exemplary embodiment, when it is determined that the display apparatus 200 is located within the predetermined range of the POI, the controller 250 determines whether the display apparatus 200 is located on the POI for a predetermined time, based on the location information on the display apparatus 200. When it is determined that the display apparatus 200 is located on the POI for the predetermined time, the controller 250 determines that there is a user activity on the POI.

To be specific, the controller 250 may set a critical range of each POI based on location information included in each of the POI information which are pre-stored in the storage 230 and a critical range which is set for each category. When current location information on the display apparatus 200 is received through the location information receiver 240, the controller 250 determines whether there is a POI including location information corresponding to the POI based on a predetermined range of each POI. For example, when the current location information on the display apparatus 200 is located within a predetermined range of a POI of “OOO Library” among a plurality of POIs, the controller 250 determines that the user of the display apparatus 200 conducted an activity on the POI of “OOO Library.”

At this point, the controller 250 determines whether at least one location information received through the location information receiver 240 during the predetermined time of the POI of “OOO Library” is located within the predetermined range of the POI of “OOO Library.” When it is determined that the display apparatus 200 is located within the predetermined range of the POI of “OOO Library” for the predetermined time, the controller 250 finally determines that the user of the display apparatus 200 conducted an activity on the POI of “OOO Library.”

Subsequently, the controller 250 generates and stores activity POI information which shows that the user of the display apparatus 200 conducted an activity on the POI of “OOO Library” in the storage 230, based on the finally determined result. Herein, the activity POI information may include at least one of location information, name information, and time information on the POI of “OOO Library.”

Meanwhile, when a user command is inputted through the input unit 270, the controller 250 controls the display 260 to display an analysis result of a user activity based on time information included in at least one activity POI information which is pre-stored in the storage 230.

According to an exemplary embodiment, the controller 250 controls the display 260 to display activity POI information according to a chronological order based on the time information included in the activity POI information pre-stored in the storage 230. Hence, the display 260 may arrange and display the activity POI information pre-stored in the storage 230 according to a chronological order.

According to another exemplary embodiment, the controller 250 determines a ratio of each of the activity POI information with respect to entire activity POI information based on the time information included in at least one activity POI information which is pre-stored in the storage 230. Subsequently, the controller 250 may control the display 260 to display each of the activity POI information according to a category based on the determined ratio. Hence, the display 260 may display an activity ratio of each of the activity POI information according to a category while arranging and displaying the activity POI information according to a chronological order.

According to another exemplary embodiment, the controller 250 may control the display 260 to display each of the activity POI information on a pre-stored map based on the time information and location information included in at least one activity POI information pre-stored in the storage 230. Hence, the display 260 may display each of the activity POI information on the map. At this point, the display 260 may also display a moving trajectory of each of the activity POI information displayed on the map.

Meanwhile, as described above, the communication unit 210 may perform communication with the circumjacent terminal apparatus 300 which is capable of wireless communication, and may transmit and receive location information. When the location information on the terminal apparatus 300 is received from a plurality of terminal apparatuses 300 through the communication unit 210, the controller 250 determines whether the terminal apparatus 300 is registered based on identification information included in the received location information received from each terminal apparatus 300.

When it is determined that at least one terminal apparatus 300 is preregistered, the controller 250 determines whether the terminal apparatus 300 is located within a predetermined range of a POI which is determined that there is a user activity or located for a predetermined time on the POI. When it is determined that the terminal apparatus 300 is located within the predetermined range of the POI which is determined that there is a user activity or located for the predetermined time on the POI, the controller 250 determines that there is a sharing activity between the user of the terminal apparatus 300 and the user of the display apparatus 200 on the POI. Subsequently, the controller 250 generates sharing activity information regarding the determined sharing activity, and matches and stores the generated sharing activity information with activity POI information generated in connection with the POI which is determined that there is a user activity in the storage 230. Herein, the sharing activity information may include at least one of user information, location information, and time information on the terminal apparatus 300 which is located on the POI which is determined that there is a user activity.

Meanwhile, when a user command is inputted through the input unit 270, the controller 250 controls the display 260 to display an analysis result of a user activity based on the time information included in the sharing activity information matched with at least one activity POI information pre-stored in the storage 230 and at least one activity POI information.

According to an exemplary embodiment, the controller 250 controls the display 260 to display activity POI information according to a chronological order based on the time information included in the activity POI information pre-stored in the storage 230. At this point, the controller 250 determines whether there is sharing activity information matched with the activity POI information pre-stored in the storage 230. When it is determined that the sharing activity information is matched with at least one activity POI information, the controller 250 controls the display 260 to also display the sharing activity information matched with the activity POI information on a point where the activity POI information is displayed.

Hence, the display 260 arranges and displays the activity POI information pre-stored in the storage 230 and the pre-stored activity POI information according to a chronological order. At this point, the display 260 also displays the sharing activity information matched with at least one of the activity POI information arranged according to a chronological order.

According to another exemplary embodiment, the controller 250 determines a ratio of each of the sharing activity information with respect to entire sharing activity information based on the time information included in sharing activity information pre-stored in the storage 230. Subsequently, the controller 250 controls the display 260 to display each of the sharing activity information based on the determined ratio. Hence, the display 260 may visually display an activity ratio of each of the sharing activity information stored in the storage 230.

As above, each configuration of the display apparatus 200 has been explained in detail. Hereinafter, an operation of analyzing activity POI information pre-stored in the display apparatus 200 and displaying the analysis result thereof will be explained in detail.

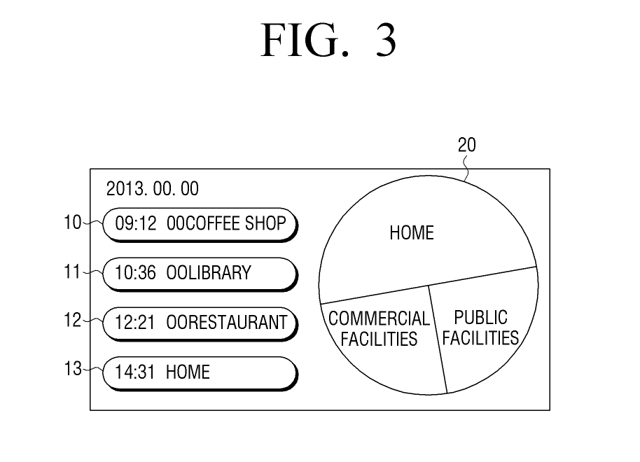

FIG. 3 is a first demonstration diagram which illustrates an operation of displaying a result analyzed based on activity POI information on a display apparatus according to an exemplary embodiment.

As shown in FIG. 3, the storage 230 of the display apparatus 200 may store a plurality of activity POI information. When a user command is inputted while the plurality of activity POI information are stored, the controller 250 obtains activity POI information corresponding to a particular period based on the time information included in the pre-store activity POI information. For example, when a command regarding an analysis result of activity POI information which shows that a user conducted an activity on a certain day of a certain month is inputted, the controller 250 may obtain activity POI information which shows that a user conducted an activity on a certain day of a certain month in 2013 based on the time information included in the plurality of pre-stored activity POI information. As shown, activity information 10 through 13 on “OO Coffee shop,” “OO Library,” “00 Restaurant,” and “Home.” When each of the activity POI information 10 through 13 is obtained, the controller 250 controls the display 260 to display each of the activity POI information 10 through 13 according to a chronological order based on the time information included in each of the activity POI information 10 through 13.

In addition, the controller 250 determines a ratio of each of activity POI information with respect to entire activity POI information which shows that a user conducted an activity on a certain day of a certain month in 2013 based on the time information included in each of the activity POI information 10 through 13. Subsequently, the controller 250 may control the display 260 to display each of the activity POI information 10 through 13 according to a category based on the determined ratio.

For example, a user may conduct an activity on a POI of “OO Coffee shop” and a POI of “OO Restaurant” for one hour respectively, may conduct an activity on a POI of “OO Library” for three hours, and may conduct an activity on a POI of “Home” for five hours. In this case, the controller 250 determines an activity ratio of each POI based on entire activity time according to an activity on each POI and activity time on each POI. At this point, when at least two or more POIs among the POIs belong to a same category, the controller 250 may determine an activity ratio with respect to the entire activity time of the POIs which belong to the same category. As specified above, the POI of “OO Coffee shop” and the POI of “OO Restaurant” may be classified into a category regarding the commercial facilities, the POI of “OO Library” may be classified into a category regarding the public institutions, and the POI of “Home” may be classified into a category regarding the personal setting.

As above, when an activity ratio of each POI is determined based on the entire activity time according to the activity on each POI and the activity time of each POI, the controller 250 controls the display 260 to display an activity ratio result of each POI according to a category. Accordingly, the display 260 may display each of the activity POI information 10 through 13 on a left area according to a chronological order, and may visually display the activity ratio result according to a category on a right area through a ratio graph 20 such as a circular graph.

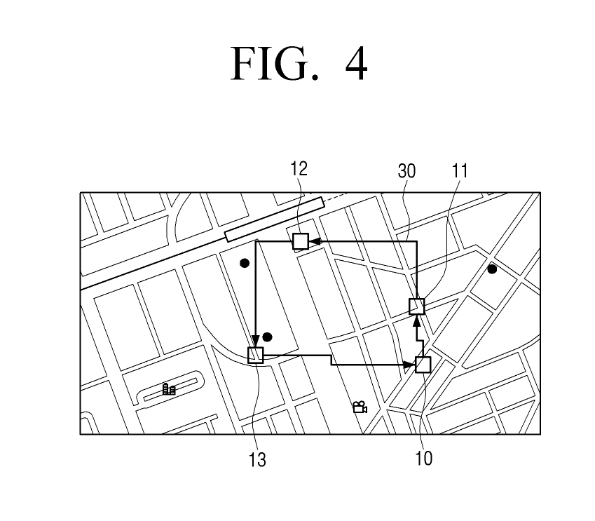

FIG. 4 is a second demonstration diagram which illustrates an operation of displaying a result analyzed based on activity POI information on a display apparatus according to another exemplary embodiment.

As shown in FIG. 4, the controller 250 controls the display 260 to display each of the activity POI information 10 through 13 on a pre-stored map based on the location information and the time information included in each of the activity POI information 10 through 13 which show that a user conducted an activity on a certain day of a certain month in 2013. Hence, the display 260 displays each of the activity POI information 10 through 13 which show that user conducted an activity on a certain day of a certain month in 2013 on the map. At this point, the display 260 may also display a moving trajectory based on the time information included in each of the activity POI information 10 through 13. For example, a user may conduct activities in an order of “OO Coffee shop,” “OO Library,” “00 Restaurant,” and “Home.” In this case, the display 260 may display the activity POI information 10 through 13 on “OO Coffee shop,” “OO Library,” “OO Restaurant,” and “Home” and the moving trajectory of each of the activity POI information 10 through 13 on the map.

Accordingly, the user may monitor his/her activity history based on of the activity POI information 10 through 13 displayed on the map and the moving trajectory 30 of each of the activity POI information 10 through 13.

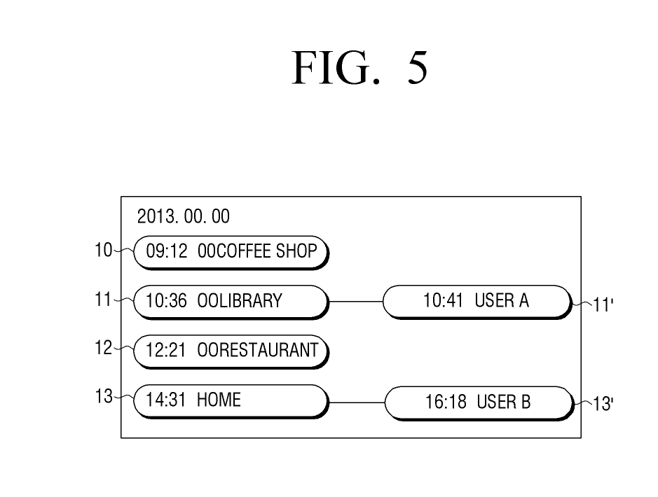

FIG. 5 is a demonstration diagram which illustrates an operation of displaying a result analyzed based on activity POI information and sharing activity information on a display apparatus according to an exemplary embodiment.

As shown in FIG. 5, the controller 250 may obtain activity POI information which shows that a user conducted an activity on a certain day of a certain month in 2013 based on a user command. As shown, the activity POI information 10 through 13 on “00 Coffee shop,” “OO Library,” “OO Restaurant,” and “Home” may be obtained. When each of the activity POI information 10 through 13 is obtained, the controller 250 controls the display 260 to arrange and display each of the activity POI information 10 through 13 according to a chronological order based on the time information included in each of the activity POI information 10 through 13. Hence, the display 260 may display each of the activity POI information 10 through 13 according to a chronological order.

Meanwhile, the activity POI information 11, 13 on “OO Library” and “Home” among the activity POI information 10 through 13 may be matched with sharing activity information 11′, 13′. In this case , the controller 250 may control the display 260 to arrange and display each of the activity POI information 10 through 13 according to a chronological order, and also display the sharing activity information 11′, 13′ matched with the activity POI information 11, 13 on a point where the activity POI information 11, 13 on “OO Library” and “Home” are displayed.

Hence, the display 260 may match and display activity POI information 20 on “OO Library” and “Home” among the activity POI information 10 through 13 displayed according to a chronological order with the sharing activity information 11′, 13′.

Hence, a user is able to monitor that the user conducted an activity on the POI of “OO Library” with user A, and conducted an activity on the POI of “Home” with user B.

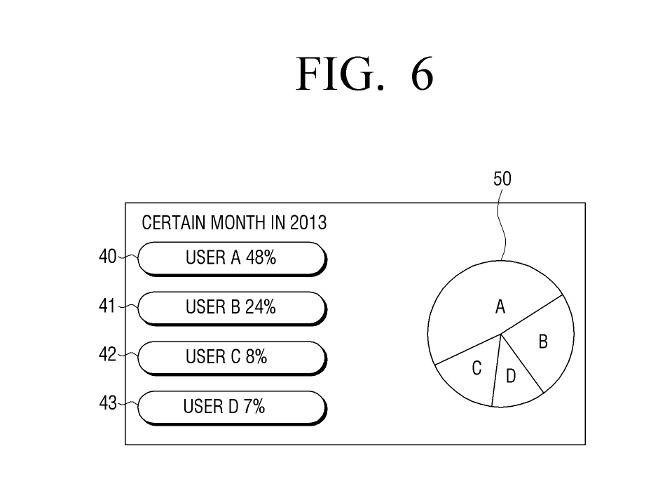

FIG. 6 is a demonstration diagram which illustrates an operation of displaying a result analyzed based on sharing activity information on a display apparatus according to another exemplary embodiment.

As shown in FIG. 6, when a user command is inputted, the controller 250 obtains sharing activity information corresponding to a particular period based on the time information included in the plurality of sharing activity information pre-stored in the storage 230. For example, when a command regarding an analysis result of sharing activity information which shows that a user conducted an activity on a certain month in 2013 is inputted, the controller 250 may obtain sharing activity information which shows that the user conducted an activity on a certain month in 2013 based on the time information included in the plurality of pre-stored sharing activity information. As shown, sharing activity information 40 through 43 of users A through D may be obtained. When each of the sharing activity information 40 through 43 is obtained, the controller 250 determines a ratio of each of the sharing activity information with respect to entire sharing activity information based on the time information included in each of the sharing activity information 40 through 43. Subsequently, the controller 250 may control the display 260 to display each of the sharing activity information 40 through 43 based on the determined ratio.

For example, it may be determined that a sharing activity ratio between the user A and the user of the display apparatus 200 is a highest ratio, a sharing activity ratio between the user B and the user of the display apparatus 200 is a second highest ratio, a sharing activity ratio between the user C and the user of the display apparatus 200 is a third highest ratio, and a sharing activity ratio between the user D and the user of the display apparatus 200 is a lowest ratio.

As above, when a sharing activity ratio between the users A through D and the user of the display apparatus 200 is determined based on the time information included in each of the sharing activity information 40 through 43, the controller 250 controls the display 260 to display the sharing activity information 40 through 43 on the users A through D based on the determined sharing activity ratio.

Hence, the display 260 may display each of the sharing activity information 40 through 43 according to an order of a highest sharing activity ratio on the left area, and may visually display a ratio result of each of the sharing activity information 40 through 43 on the right area through a ratio graph 50 such as a circular graph.

Hereinafter, a method for controlling the display apparatus 200 will be described in detail.

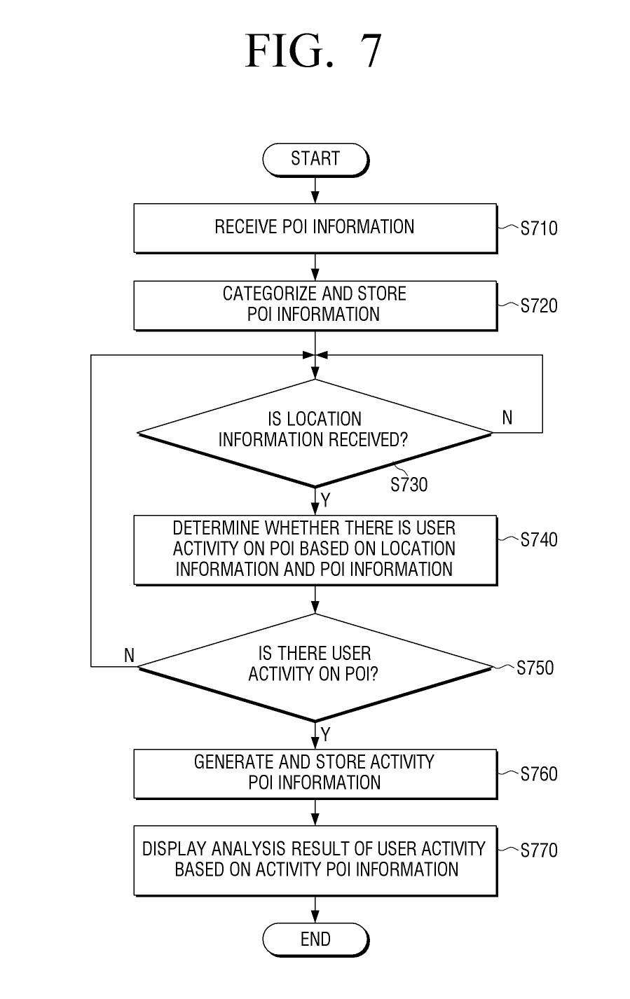

FIG. 7 is a flow chart which illustrates a method for controlling a display apparatus according to an exemplary embodiment.

As shown in FIG. 7, the display apparatus 200 performs communication with the POI server 100 periodically, and receives POI information pre-stored in the POI server 100 (S710). When the POI information is received, the display apparatus 200 stores the received POI information in the storage (S720). At this point, the display apparatus 200 categorizes and stores the received POI information based on a predetermined hierarchical categorization condition.

For example, POI information on a school, a hospital, a police station, and a fire station may be classified into the category regarding the public institution, and POI information on a library, a civic center, health and welfare facilities, and a park may be classified into the category regarding the public facilities. In addition, POI information on a market, a department store, a restaurant, a cafe, and an office building may be classified into the category regarding the commercial facilities, and POI information on a bathing beach, a camping ground, an arboretum, and an amusement park may be classified into a category regarding the tourist spot. In addition, POI information which is registered in the POI server 100 by the user of the display apparatus 200 may be classified into the category regarding the personal setting. For example, when POI information on a home of the user is registered in the POI server 100 by the user, the POI information on the home may be classified into the category regarding the personal setting. As such, when each POI information is categorized, the display apparatus 200 stores the categorized POI information in the storage.

At this point, the display apparatus 200 may differently set and store at least one of a critical range and a critical time according to a category. For example, in the category regarding the tourist spot, a critical range may be set broader than a critical range of other categories, or a critical time may be set longer than a critical time of other categories, and in the category regarding the public institution, a critical range may be set narrower than a critical range of other categories, or a critical time may be set shorter than a critical time of other categories.

Accordingly, the display apparatus 200 may classify and store the POI information received from the POI server 100 into each of the categories where the critical range and the critical time thereof are set differently.

Meanwhile, the display apparatus 200 receives location information from the GPS satellite (not shown) periodically. Accordingly, the display apparatus 200 determines whether location information is received from the GPS satellite (not shown) while POI information are classified and stored according to a category (S730). When it is determined that the location information is received from the GPS satellite (not shown), the display apparatus 200 determines whether there is a user activity on a particular POI based on the received location information and pre-stored POI information, and determines whether there is a user activity on the POI based on the determined result (S740, S750). When it is determined that there is no user activity on the POI, the display apparatus 200 may determine whether there is a user activity on a particular POI based on new location information received from the GPS satellite (not shown) and the pre-stored POI information.

Meanwhile, when it is determined that there is a user activity on the POI, the display apparatus 200 generates and stores activity POI information according to the user activity on the POI in the storage (S760).

According to an exemplary embodiment, the display apparatus 200 may determine whether there is a user activity on the POI by determining whether the display apparatus 200 is located within a predetermined range of the POI based on the categorized POI information and the location information on the display apparatus 200 received from the GPS satellite (not shown).

According to another exemplary embodiment, when the display apparatus 200 is located within the predetermined range of the particular POI, the display apparatus 200 may determine whether there is a user activity on the POI by determining whether the display apparatus 200 is located on the POI for a predetermined time based on the location information on the display apparatus 200.

To be specific, the display apparatus 200 may set a critical range of each POI based on the location information included in each of the pre-stored POI information and a critical range which is set according to a category. In addition, the display apparatus 200 may set a critical time of each POI based on a critical time which is set according to a category.

Accordingly, when current location information on the display apparatus 200 is received from the GPS satellite (not shown), the display apparatus 200 determines whether there is a POI including the location information received from the GPS satellite (not shown) based on a predetermined range of each POI. When it is determined that there is a POI including the received location information, the display apparatus 200 determines whether at least one location information received from the GPS satellite (not shown) during the predetermined time of the POI is located within the predetermined range of the POI. When it is determined that the display apparatus 200 is located within the predetermined range of the POI for the predetermined time, the display apparatus 200 may finally determine that the user of the display apparatus 200 conducted an activity on the POI, and may generate and store activity POI information according to the determined result.

When a user command is inputted while the activity POI information is stored, the display apparatus 200 displays an analysis result of a user activity based on the time information included in the pre-stored activity POI information (S770).

According to an exemplary embodiment, the display apparatus 200 may display the activity POI information according to a chronological order based on the time information included in the pre-stored activity POI information.

According to an exemplary embodiment, the display apparatus 200 determines a ratio of each of the activity POI information with respect to entire activity POI information based on the time information included in at least one pre-stored activity POI information. Subsequently, the display apparatus 200 may display an activity ratio of each of the activity POI information according to a category while arranging and displaying the activity POI information according to a chronological order.

According to another exemplary embodiment, the display apparatus 200 may display each of the activity POI information on a pre-stored map based on the time information and the location information included in at least one pre-stored activity POI information. At this point, the display apparatus 200 may also display the moving trajectory of each of the activity POI information displayed on the map.

Meanwhile, the display apparatus 200 may provide an analysis result of a use activity according to a sharing activity between the user of the display apparatus 200 and an acquaintance. Hereinafter, a method of providing the analysis result of the use activity according to the sharing activity between the user of the display apparatus 200 and the acquaintance on the display apparatus 200 will be described in detail.

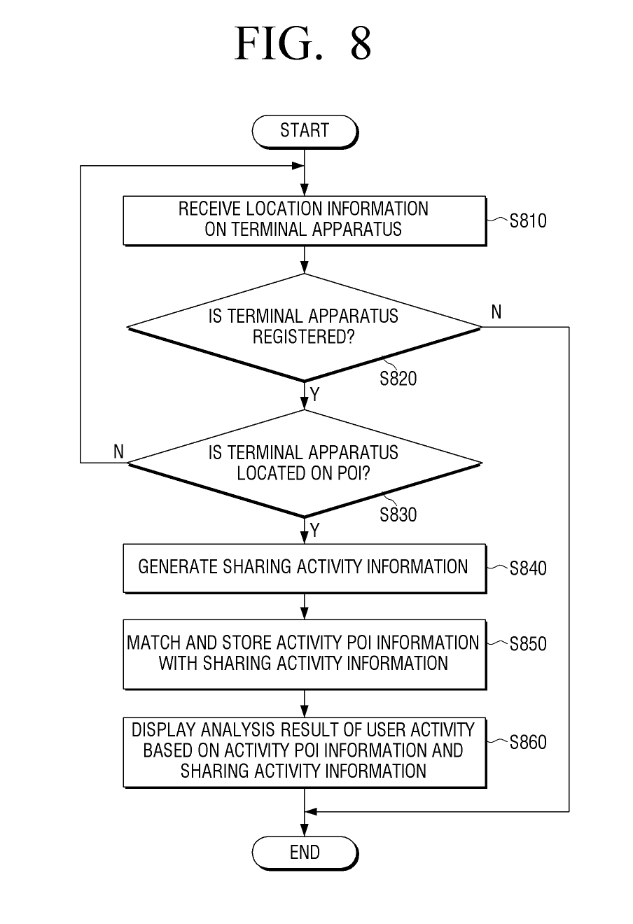

FIG. 8 is a flow chart which illustrates a method of providing the analysis result of the user activity according to the sharing activity on the display apparatus according to an exemplary embodiment.

As shown in FIG. 8, when activity POI information according to a user activity on a particular POI is generated through the aforementioned operation 5760, the display apparatus 200 performs communication with at least one circumjacent terminal apparatus 300 capable of wireless communication, and transmits and receives location information (S810). When the location information on the terminal apparatus 200 is received from the at least one terminal apparatus 300 is received, the display apparatus 200 determines whether the terminal apparatus 300 is a preregistered terminal apparatus based on identification information included in the received location information (S820). When it is determined that the terminal apparatus 300 is a preregistered terminal apparatus, the display apparatus 200 determines whether the terminal apparatus 300 is located within the predetermined range of the POI which is determined that there is a user activity for the predetermined time based on the location information received from the terminal apparatus 300 (S830).

As explained above, the display apparatus 200 determines whether the terminal apparatus 300 is located within the predetermined range of the POI which is determined that there is a user activity based on the location information received from the terminal apparatus 300. When it is determined that the terminal apparatus 300 is located within the predetermined range of the POI, the display apparatus 200 determines whether at least one location information received from the terminal apparatus 300 during a predetermined critical time of the POI is located within the predetermined range of the POI. When it is determined that the terminal apparatus 300 is located within the predetermined range of the POI for the predetermined critical time, the display apparatus 200 determines that there is a sharing activity between the user of the terminal apparatus 300 and the user of the display apparatus 200 on the POI, and generates sharing activity information corresponding to the sharing activity (S840). Herein, the sharing activity information may include at least one of user information, location information, and time information on the terminal apparatus 300 which is located on the POI which is determined that there is a user activity.

Subsequently, the display apparatus 200 matches and stores the activity POI information which is generated in connection with the POI which is determined that there is a user activity with pre-generated sharing activity information (S850).

When a user command is inputted, the display apparatus 200 displays an analysis result of a user activity based on the pre-stored activity POI information and the time information included in the sharing activity information which is matched with at least one activity POI information (S860).

According to an exemplary embodiment, the display apparatus 200 displays the activity POI information according to a chronological order based on the time information included in the pre-stored activity POI information. At this point, when the sharing activity information is matched with at least one of the pre-stored activity POI information, the display apparatus 200 also displays the sharing activity information which is matched with the activity POI information on a point where the activity POI information is displayed.

According to another exemplary embodiment, the display apparatus 200 determines a ratio of each of the sharing activity information with respect to entire sharing activity information based on the time information included in the pre-stored sharing activity information. Subsequently, the display apparatus 200 visually displays an activity ratio of each of the sharing activity based on the determined ratio.

Although a few exemplary embodiments have been shown and described, it will be understood by those skilled in the art to which the present disclosure pertains that various changes in form and details may be made therein without deviating from the substance of the present invention which is claimed in the claims, and such modifications should not be understood separately from the technical concept or prospect of the present disclosure.

What is claimed is:

1. A communication apparatus comprising:
a communication unit configured to receive point of interest (POI) information from a POI server;
a storage configured to store the received POI information;
a location information receiver configured to receive location information on the communication apparatus; and
a controller configured to determine whether there is a user activity on a POI based on the location information received by the location information receiver and the POI information stored in the storage, and store activity POI information according to the determined user activity in the storage.

2. The apparatus as claimed in claim 1, further comprising:
a category unit configured to categorize the received POI information based on a predetermined hierarchical categorization condition, and store the categorized POI information in the storage.

3. The apparatus as claimed in claim 2, wherein when the communication apparatus is located within a predetermined range of the POI based on the categorized POI information and the received location information on the communication apparatus, the controller determines that there is a user activity on the POI.

4. The apparatus as claimed in claim 1, wherein when the communication apparatus is located on the POI for a predetermined time based on the location information on the communication apparatus, the controller determines that there is a user activity on the POI.

5. The apparatus as claimed in claim 3, further comprising:
a display;
wherein the controller controls the display to display the activity POI information based on time information included in the activity POI information stored in the storage.

6. The apparatus as claimed in claim 5, wherein the controller controls the display to determine a ratio of each of activity POI information with respect to entire activity POI information based on the time information included in the activity POI information stored in the storage, and display each of the activity POI information according to a category based on the determined ratio.

7. The apparatus as claimed in claim 5, wherein the controller controls the display to display the activity POI information on a pre-stored map based on the time information and the location information included in the activity POI information stored in the storage.

8. The apparatus as claimed in claim 3, wherein the communication unit receives location information on the communication apparatus from at least one preregistered terminal apparatus periodically,
wherein when the at least one preregistered terminal apparatus is located within a predetermined range of the POI or located on the POI for a predetermined time based on the location information on the at least one preregistered terminal apparatus, the controller determines that there is a sharing activity on the POI between a user of the at least one preregistered terminal apparatus and a user of the communication apparatus, and matches and stores sharing activity information on the determined sharing activity with the activity POI information in the storage.

9. The apparatus as claimed in claim 8, further comprising:
a display;
wherein the controller controls the display to display the activity POI information and the sharing activity information based on the time information included in the activity POI information and the sharing activity information stored in the storage.

10. The apparatus as claimed in claim 9, wherein the controller controls the display to determine a ratio of each of sharing activity information with respect to entire sharing activity information based on the time information included in the sharing activity information stored in the storage, and display each of the sharing activity information based on the determined ratio.

11. A method for controlling a communication apparatus, the method comprising:
receiving POI information from a POI server;
storing the received POI information;
receiving location information on the communication apparatus;
determining whether there is a user activity on a POI based on the received location information and the stored POI information; and
storing activity POI information according to the determined user activity.

12. The method as claimed in claim 11, wherein the storing the received POI information further comprises categorizing and storing the received POI information based on a predetermined hierarchical categorization condition.

13. The method as claimed in claim 12, wherein the determining comprises, when the communication apparatus is located within a predetermined range of the POI based on the categorized POI information and the received location information on the communication apparatus, determining that there is a user activity on the POI.

14. The method as claimed in claim 11, wherein the determining comprises, when the communication apparatus is located on the POI for a predetermined time based on the location information on the communication apparatus, determining that there is a user activity on the POI.

15. The method as claimed in claim 13, further comprising:
displaying the activity POI information based on time information included in pre-stored activity POI information.

16. The method as claimed in claim 15, wherein the displaying comprises determining a ratio of each of activity POI information with respect to entire activity POI information based on time information included in the pre-stored activity POI information, and displaying each of the activity POI information according to a category based on the determined ratio.

17. The method as claimed in claim 15, wherein the displaying comprises displaying the activity POI information on a pre-stored map based on the time information and the location information included in the pre-stored activity POI information.

18. The method as claimed in claim 13, wherein the receiving location information further comprises periodically receiving location information on the communication apparatus from at least one preregistered terminal apparatus,
wherein the determining comprises, when the at least one preregistered terminal apparatus is located within a predetermined range of the POI or located on the POI for a predetermined time based on the location information on the at least one preregistered terminal apparatus, determining that there is a sharing activity on the POI between a user of the at least one preregistered terminal apparatus and a user of the communication apparatus,
wherein the storing activity POI information further comprises matching and storing sharing activity information on the determined sharing activity with the activity POI information.

19. The method as claimed in claim 18, further comprising:
displaying the activity POI information and the sharing activity information based on the time information included in the pre-stored activity POI information and the sharing activity information.

20. The method as claimed in claim 19, wherein the displaying comprises determining a ratio of each of sharing activity information with respect to entire sharing activity information based on the time information included in the pre-stored sharing activity information, and displaying the sharing activity information based on the determined ratio.
